(19) United States
(12) Patent Application Publication
(10) Pub. No.: US 2025/0114955 A1
(43) Pub. Date: Apr. 10, 2025

(54) SLIDER CARTRIDGE FOR OUT THE FRONT KNIFE

(71) Applicant: KAI U.S.A., LTD., Tualatin, OR (US)

(72) Inventors: Eric Shawn MOORE, Lake Oswego, OR (US); James Duncan MACNAIR, Newberg, OR (US)

(21) Appl. No.: 18/481,095

(22) Filed: Oct. 4, 2023

(51) Int. Cl. B26B 1/08; B26B 1/10

(52) U.S. Cl. CPC B26B 1/08; B26B 1/10

(57) ABSTRACT

A slider cartridge for an out-the-front knife and method of assembly is provided. The out-the-front knife includes a knife handle and a knife blade that is selectively deployable out of a front of the knife handle to move from a stowed position within the handle to a deployed position out of the handle. The slider cartridge includes a slider plate, a pair of opposing catches, and at least one biasing element. The pair of opposing catches are configured to be retained on opposing ends of the slider plate under a bias of the at least one biasing element in a self-retained assembly that is manipulable in space apart from the knife handle and the knife blade. The pair of catches further include opposing tabs that protrude outwardly from a center of the catch to assist in securing each respective catch to an opposing end of the slider plate.

### BACKGROUND

### Technical Field

The present disclosure relates to out-the-front (OTF) knives and, more particularly, to a slider cartridge for out-the-front knives, and to associated methods of assembly.

### Description of the Related Art

Out-the-front knives are a practical tool where the knife blade is housed or concealed within the knife handle. Out-the-front knifes enjoy wide popularity, particularly amongst sportsmen, campers, hikers, and others who engage in outdoor activities. Common elements of out-the-front knives include a knife handle, a knife blade, a slider plate, catches, and a biasing element such as a spring. The knife blade deploys from its concealed position out the front of the knife handle using a release action mechanism, which includes the slider plate, the catches, and the biasing element. An example of an out-the-front knife may be found in U.S. Pat. No. 7,305,769.

A typical drawback that has been encountered with out-the-front knives having a slider plate and catches is that during assembly, the catches have a significant probability of sliding off or “walking off” the slider plate, thus causing the assembly of the knife to be difficult or cumbersome. Such unintended assembly problems and deficiencies delay production and result in other drawbacks.

### BRIEF SUMMARY

Embodiments of out-the front knives, slider cartridges thereof, and methods of assembly disclosed herein enable improved manufacturability and provide other benefits including consistent operability.

An embodiment of a slider cartridge for an out-the-front knife having a knife handle and a knife blade that is selectively deployable out of a front of the knife handle to move from a stowed position within the handle to a deployed position out of the handle may be summarized as including: a slider plate; a pair of opposing catches; and at least one biasing element, wherein the pair of opposing catches are configured to be retained on opposing ends of the slider plate under a bias of the at least one biasing element in a self-retained assembly that is manipulable in space apart from the knife handle and the knife blade.

Each of the pair of catches may include opposing tabs that are operable to assist in securing each respective catch on a respective one of the opposing ends of the slider plate, the opposing tabs protruding outwardly from a center of the catch to catch on the slider plate. The slider plate may include a respective catch engaging slot on each of the opposing ends of the slider plate to insertably receive a respective one of the opposing catches. The catch engaging slots may be defined by a slot width, and the opposing tabs of each of the opposing catches may protrude outwardly beyond the slot width such that the opposing tabs overlap with portions of the slider plate adjacent to the catch engaging slots. The opposing tabs of each of the opposing catches may be configured to abut a backside of the slider plate to assist in retaining the opposing catches on the slider plate in the self-retained assembly. A slider plate engaging end of each of the opposing catches, which includes the opposing tabs, may be provided in a form factor that is configured to nest with the opposing ends of the slider plate to assist in retaining the opposing catches on the slider plate in self-retained assembly. Each of the opposing catches may include at least one aperture configured to detachably receive a respective end of the at least one biasing element such that, in an assembled state of the slider cartridge, the at least one biasing element extends between the opposing catches. The slider cartridge may further comprise two biasing elements coupled between the opposing catches and extending along an outer face of the slider plate. The pair of opposing catches may be of identical form.

In some embodiments, an out-the-front knife may comprise the slider cartridge as described above. The out-the-front-knife may further comprise a detent mechanism, and the detent mechanism may be positioned at a rear end of the out-the-front knife within the knife handle to interact with a tang of the knife blade to secure the knife blade in the stowed position until a bias of the detent mechanism is overcome by movement of the slider plate. The out-the-front knife may further comprise a detent mechanism, and the detent mechanism may be positioned at a front end of the out-the-front knife within the knife handle to interact with a tang of the knife blade to secure the knife blade in the deployed position until a bias of the detent mechanism is overcome by movement of the slider plate. The out-the-front knife may further comprise a moveable engagement member coupled to the knife handle to move in fore and aft directions and operable in conjunction with the slider plate to move the knife blade between the stowed position and the deployed position.

Another embodiment of an out-the-front knife may be summarized as including: a knife handle; a knife blade that is selectively deployable out of a front of the knife handle to move from a stowed position within the handle to a deployed position out of the handle; and a slider cartridge having a slider plate, a pair of opposing catches, and at least one biasing element coupled to the opposing catches to bias the opposing catches toward each other, each of the catches including a pair of opposing tabs extending outwardly from a center of the catch beyond a respective catch engaging slot in each of a respective end of the slider plate to assist in securing the catches on the slider plate in a self-retained assembly.

The catch engaging slots may be defined by a slot width, and the opposing tabs of each of the opposing catches may protrude outwardly beyond the slot width such that the opposing tabs overlap with portions of the slider plate adjacent to the catch engaging slots. The opposing tabs of each of the opposing catches may be configured to abut a backside of the slider plate to assist in retaining the opposing catches on the slider plate in the self-retained assembly. A slider plate engaging end of each of the opposing catches, which includes the opposing tabs, may be provided in a form factor that is configured to nest with the opposing ends of the slider plate to assist in retaining the opposing catches on the slider plate in the self-retained assembly. The slider cartridge may be configured to interact with a first detent mechanism at a rear end of the knife handle to assist in deploying the knife blade from the stowed configuration and to interact with a second detent mechanism at a front end of the knife handle to assist in returning the knife blade to the stowed configuration.

A method of assembling an out-the-front knife having a knife handle and a knife blade that is selectively deployable out of a front of the knife handle to move from a stowed position within the handle to a deployed position out of the handle may be summarized as including: providing a slider plate, a pair of opposing catches, and at least one biasing element; and configuring the pair of opposing catches on opposing ends of the slider plate under a bias of the at least one biasing element to form a self-retained slider cartridge. The method may further include positioning the self-retained slider cartridge between opposing portions of the knife handle, the slider cartridge being manipulable in space apart from the portions of the knife handle and the knife blade.

### BRIEF DESCRIPTION OF THE SEVERAL VIEWS OF THE DRAWINGS

FIG. 1 is a perspective view of an out-the-front knife, according to an example embodiment of the present disclosure, in a stowed configuration in which a knife blade of the out-the-front knife is concealed within a knife handle.

FIG. 2 is a perspective view of the out-the-front knife of FIG. 1 in a deployed configuration, in which the knife blade is extended out the front of the knife handle for use.

FIG. 3 is a perspective view of the out-the-front knife of FIG. 1 in the stowed configuration with a portion of the knife handle removed to reveal underlying components and features.

FIG. 4 is perspective view of the out-the-front knife of FIG. 1 in an intermediate pre-firing configuration prior to deployment of the knife blade with a portion of the knife handle removed to reveal underlying components and features.

FIG. 5 is a perspective view of the out-the-front knife of FIG. 1 in the deployed configuration with the knife blade fully extended out of the front of the knife handle for use and with a portion of the knife handle removed to reveal underlying components and features.

FIG. 6 is a perspective view of the out-the-front knife of FIG. 1 in an intermediate pre-retraction configuration prior to retraction of the knife blade with a portion of the knife handle removed to reveal underlying components and features.

FIG. 7 is a front perspective view of a slider cartridge of the out-the-front knife of FIG. 1 shown isolated from the remainder of the knife.

FIG. 8 is a rear perspective view of the slider cartridge of the out-the-front knife of FIG. 1 shown isolated from the remainder of the knife.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known devices, structures and techniques associated with knives, components thereof and related methods of assembling knives may not be shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

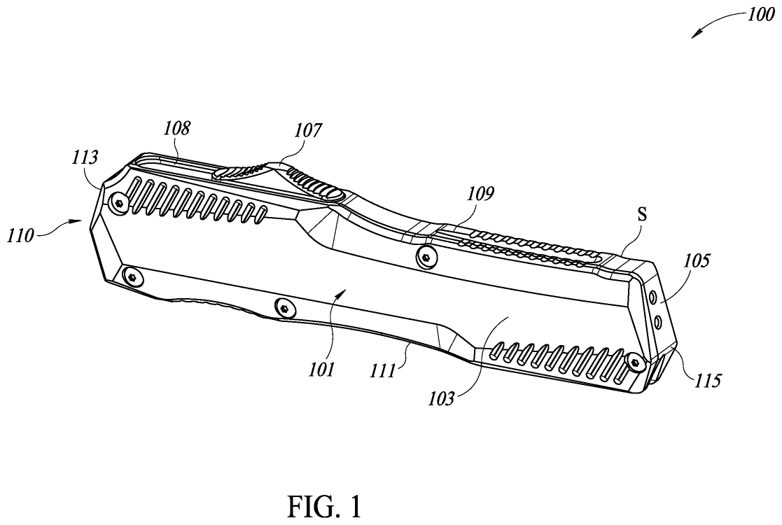

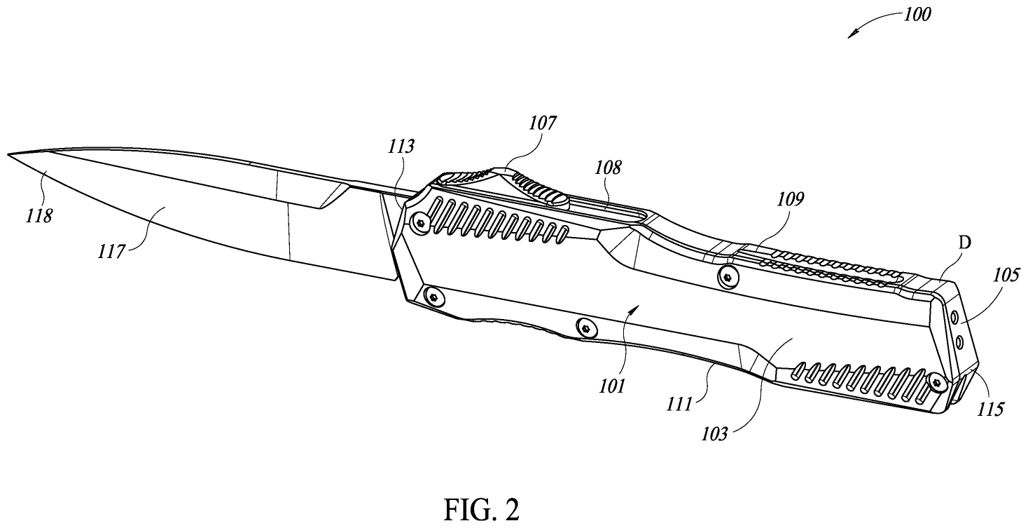

FIGS. 1 and 2 show a perspective view of an out-the-front knife 100 according to one example embodiment in a stowed configuration S and a deployed configuration D, respectively. The out-the-front knife 100 includes a knife handle 101 and a knife blade 117 (FIG. 2), which is deployable from the knife handle 101. The knife handle 101 includes a first portion 103 and a second portion 105 that are positioned opposite of each other and couplable together to form the knife handle 101 with one or more components of the knife 100 retained therein.

An engagement member 107 for enabling deployment of the knife blade 117 by a user is coupled to the knife handle 101 and is positioned on a top side 109 of the knife handle 101. The engagement member 107 may be configured as a sliding member, as shown in FIGS. 1 through 6, or may be shaped or formed in a variety of configurations that enable the deployment of the knife blade 117, as shown in FIG. 2, or subsequent stowing of the knife blade 117, as shown in FIG. 1. In the illustrated embodiment, the engagement member 107 is positioned within a guide channel 108 on the top side 109 of the knife handle 101 and is configured to move in a fore and aft manner to move the knife 100 between the stowed configuration S, shown in FIG. 1, and the deployed configuration D, as shown in FIG. 2.

The knife handle 101 includes a front end 113 and a rear end 115. The front end 113 of the knife handle 101 contains an opening 110 that allows for the knife blade 117 to deploy from the stowed configuration S of the knife 100, as shown in FIG. 1, to the deployed configuration D of the knife 100, as shown in FIG. 2. As noted above, in the deployed configuration D of the knife 100, the knife blade 117 extends out through the opening 110 in the front end 113 of the knife handle 101 to a deployed position. Conversely, in the stowed configuration S of the knife 100, the knife blade 117 is in a retracted or stowed position within the knife handle 101.

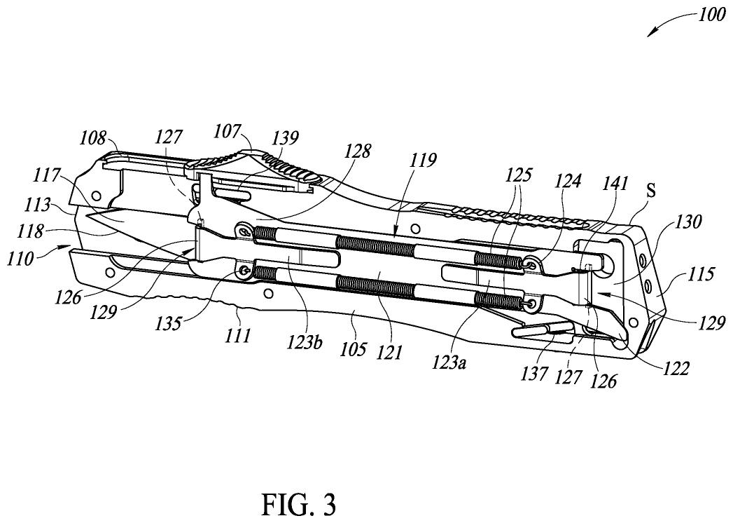

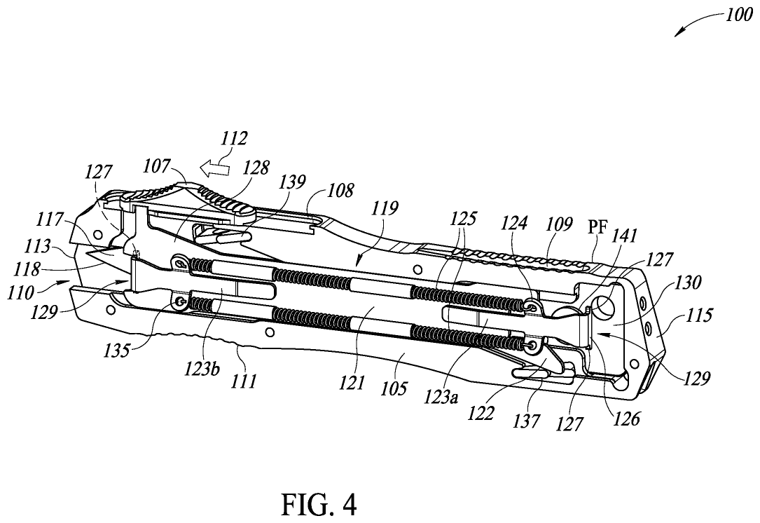

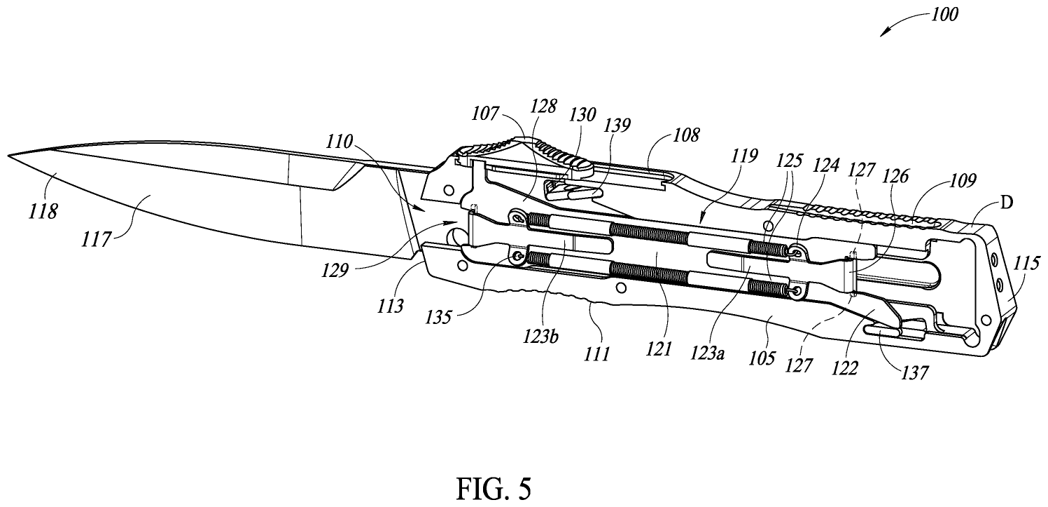

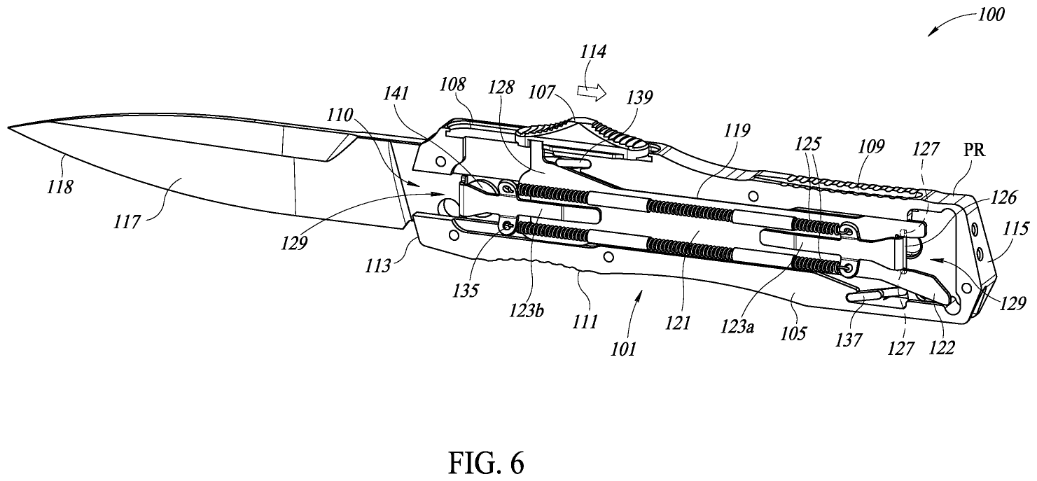

FIGS. 3 through 6 provide perspective views that illustrate various operational positions of the out-the-front knife 100 with the first portion 103 of the knife handle 101 removed to reveal underlying components and features. In operation, the knife 100 transitions from the stowed configuration S, as shown in FIG. 3, via interaction of a user with the engagement member 107 to an intermediate pre-firing configuration PF, as shown in FIG. 4, in which the engagement member 107 approaches the front end 113 of the knife 100 within the guide channel 108. From there, the user continues to push the engagement member 107 until the knife blade 117 accelerates forward to transition the knife 100 to the deployed configuration D, as shown in FIG. 5. Then, in order to retract the knife blade 117, the user may pull the engagement member 107 rearward toward an intermediate pre-retraction position PR, as shown in FIG. 6, in which the engagement member 107 approaches the back of the guide channel 108 via interaction of the user.

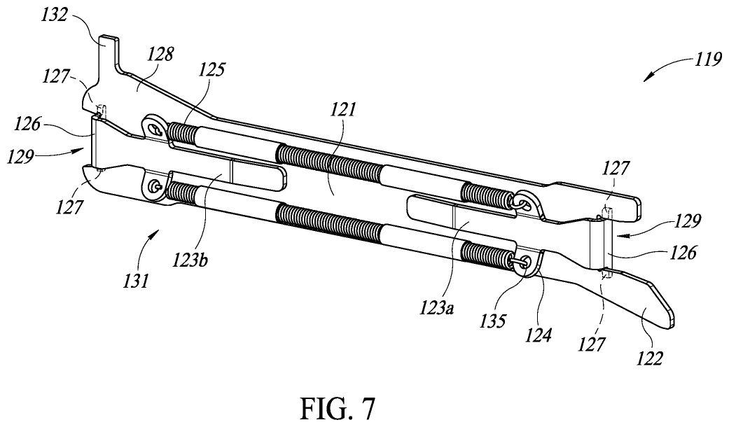

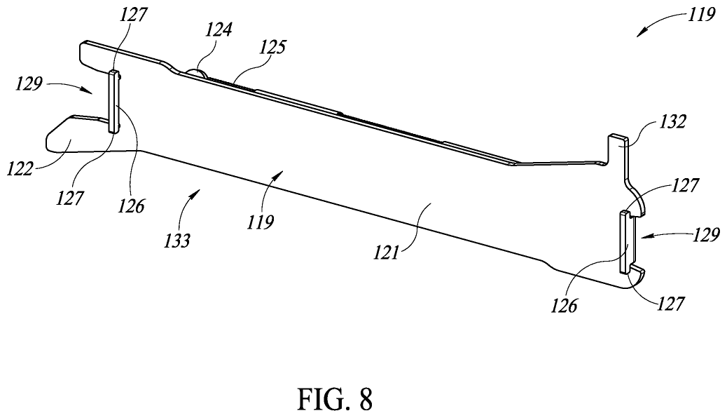

With continued reference to FIGS. 3 through 6, positioned within the knife handle 101 of the out-the-front knife 100 is a slider cartridge 119 that is configured to assist in the blade functionality described above. The slider cartridge 119 includes a slider plate 121 having a pair of opposing catches 123a, 123b and at least one biasing or spring element 125, such as an extension or other spring element, that provides a biasing force to urge the catches 123a, 123b toward each other. In some embodiments, the slider cartridge 119 may include two biasing or spring elements 125, such as, for example, a pair of adjacent extension springs as shown in FIGS. 3 through 7. The slider plate 121, opposing catches 123a, 123b, and the one or more biasing or spring elements 125 collectively form the slider cartridge 119, which is shown in isolation apart from the remainder of the knife 100 in FIGS. 7 and 8.

As shown in FIGS. 3 through 6, the slider cartridge 119 is longitudinally arranged between the portions 103, 105 of the knife handle 101 such that one end of the slider plate 121 is located near the front end 113 of the knife handle 101 associated with a front or cutting end 118 of the knife blade 117 when the knife 100 is in the stowed configuration S. Likewise, the opposing end of the slider plate 121 is located near the rear end 115 of the knife handle 101 associated with a rear or tang end 130 of the knife blade 117 when the knife 100 is in the stowed configuration S. In some embodiments, the slider cartridge 119 having the slider plate 121 and pair of catches 123a, 123b may be composed of steel or other similar material. The pair of catches 123a, 123b may be arranged on opposing ends of the slider plate 121 and securely retained therein such that the arrangement of catches 123a, 123b contributes to a much easier assembly of the knife 100 by providing a self-retained slider cartridge 119 that is manipulable in space with little risk of disassembly. In some embodiments, the pair of opposing catches 123a, 123b are configured in identical form or manner. The pair of opposing catches 123a, 123b may retain their opposing positions on the slider plate 121 under the bias of the at least one biasing or spring element 125, as shown in FIGS. 3 through 7, such as via a pair of extension springs extending between the opposing catches 123a, 123b. The biasing or spring elements 125 may be attached or hooked to the catches 123a, 123b by eyelets 124 protruding from the catches 123a, 123b. The eyelets 124 may each comprise at least one aperture 135 that allows the biasing or spring elements 125 to detachably hook to the catches 123a, 123b. The eyelets 124 may have a D-ring shape or may be another configuration that enables the biasing or spring elements 125 to detachably hook to the catches 123a, 123b.

As shown best in FIG. 8, the catches 123a, 123b may further include a catch structure 126 having a pair of opposing catch tabs 127 that are configured to extend around to and catch on a back side 133 of the slider plate 121. The pair of opposing catch tabs 127 are not limited to the size as shown in the present disclosure but may vary in size dependent on the design of the knife 100. The opposing catch tabs 127 of the catch structure 126 are configured in such a manner that the opposing catch tabs 127 protrude outwardly from a center or centerline of the catches 123a, 123b and abut or hook behind the backside 133 of the slider cartridge 119. Each opposing catch tab 127 protrudes towards the top side 109 of the knife handle 101, or towards the bottom side 111 of the knife handle 101. Each of the catches 123a, 123b, may be formed as a single unitary structure that includes the catch structure 126 and opposing catch tabs 127 thereof.

On each respective end of the slider plate 121, the opposing catch tabs 127 assist in securing the catches 123a, 123b to the slider plate 121, which advantageously collectively culminates in a self-retained assembly that is manipulable in space apart from the knife handle 101 and knife blade 117. In other words, the slider cartridge 119 may be independently handled, separate from the knife handle 101 and the knife blade 117, to facilitate case of assembly. In this configuration, the biasing or spring elements 125 may be under some tension to assist in retaining the catches 123a, 123b to the slider plate 121.

With reference to FIGS. 7 and 8, each opposing end of the slider plate 121 includes a catch engagement slot 129. Each catch engagement slot 129 insertably receives the catch structure 126 of a respective one of the catches 123a, 123b with each of the opposing catch tabs 127 of the catch structure 126 extending laterally beyond an edge of the engagement slot 129. In this manner, the catch structure 126 held within the catch engagement slot 129 helps to capture the catches 123a, 123b to the slider plate 121 and complete the independently manipulable slider cartridge 119. This makes assembly of the out-the-front knife 100 much easier. For example, without the opposing catch tabs 127 protruding outwardly from the center of the catch 123a, 123b, the catches 123a, 123b may tend to “walk off” the slider plate 121 during knife assembly.

Further operation of the knife 100 will now be described with reference again to FIGS. 3 through 6.

In FIG. 3, the knife 100 is shown secured in the stowed configuration S with the knife blade 117 retracted or stowed within the knife handle 101, and, more particularly, between portions 103, 105 of the knife handle 101. Specifically, when the knife 100 is in the stowed configuration S, the engagement member 107 is positioned all the way back within the guide channel 108 on the top side 109 of the knife handle 101. The engagement member 107 works in conjunction with the slider plate 121 and a rear detent mechanism 137 to prevent unintentional deployment of the knife blade 117. Similarly, a front detent mechanism 139 is provided to prevent unintentional retraction of the knife blade 117. The front detent mechanism 139 may take the form as shown in FIGS. 3 through 6 (i.e., spring-biased flipper), or may be in another configuration, which acts as a locking mechanism to secure the knife blade 117 in a deployed position. The front detent mechanism 139 holds the knife blade 117 in the deployed position by blocking the knife blade 117 from moving backwards until the front detent mechanism 139 is pushed out of the way of the blade 117 by a front cam portion 128 of the slider plate 121. The rear detent mechanism 137 may take the form as shown in FIGS. 3 through 6 (i.e., spring-biased flipper), or may be in another configuration, which acts as a locking mechanism to secure the knife blade 117 in a stowed position. The rear detent mechanism 137 holds the knife blade 117 in the stowed position by blocking the knife blade 117 from moving forward until the rear detent mechanism 137 is pushed out of the way of the blade 117 by a rear cam portion 122 of the slider plate 121.

In FIG. 4, the knife 100 is shown in the intermediate pre-firing position PF. The pre-firing position PF shows the engagement member 107 approaching the front end of the guide channel 108 as a user (not shown) pushes the engagement member 107 forward as indicated by an arrow 112. As the engagement member 107 moves forward within the guide channel 108, the slider plate 121 within the knife handle 101 is internally guided forward along in unison with the engagement member 107 through a connection portion 132. This movement of the engagement member 107 in conjunction with the slider plate 121 compresses the rear detent mechanism 137 by interaction from the rear cam portion 122 of the slider plate 121 to nearly clear the obstructed movement of the knife blade 117.

In the pre-firing position PF of the knife 100 shown in FIG. 4, the rear catch 123a near the rear end 115 of the knife handle 101 is hooked onto a blade pin 141 protruding from the blade tang 130 such that, as the slider plate 121 moves forward within the knife handle 101, the rear catch 123a stays in place within the knife handle 101 and is withdrawn from the catch engagement slot 129 of the slider plate 121 and increases the tension in the biasing or spring elements 125 to generate a blade deploying force. Then, as the engagement member 107 and slider plate 121 are moved just beyond the illustrated pre-firing configuration PF of FIG. 3, the rear detent mechanism 137 is compressed further by the rear cam portion 122 of the slider plate 121 to move the rear detent mechanism 137 completely out of the way of obstructing the blade tang 130 of the knife blade 117 to release the built-up blade deploying force of the biasing or spring elements 125 and pull the catches 123a, 123b back toward each other to launch the knife blade 117 forward to the fully deployed configuration D of the knife 100 shown in FIG. 5.

As shown in FIG. 5, the knife 100 blade 117 is fully deployed out the front end 113 of the out-the-front knife 100. In this deployed configuration D of the knife 100, the engagement member 107 is positioned all the way forward within the guide channel 108 of the knife handle 101. While in the deployed configuration D, the front detent mechanism 139 is urged down under the bias of a detent spring (not shown) to a position behind the back of the blade tang 130 of the knife blade 117 in order to retain the knife 100 in the open or deployed configuration D. As the knife blade 117 is deployed, at least a substantial portion of the tension from the biasing or spring elements 125 is released, and the rear catch 123a positioned towards the rear end 115 of the knife handle 101 is returned back into the engagement slot 129 of the slider plate 121 of the slider cartridge 119. In this configuration, the rear detent mechanism 137 is held in a compressed or downward position by the rear cam portion 122 of the slider plate 121. This may provide some additional frictional resistance to help secure the knife 100 in the deployed configuration D. As mentioned above, when the rear catch 123a snaps forward back into the engagement slot 129, the opposing catch tabs 127 again overlap with the slider plate 121 adjacent to the engagement slot 129 and the opposing catch tabs 127 prevent the rear catch 123a from walking off the slider plate 121. This configuration of the opposing catch tabs 127 also proves beneficial when assembling the knife, as explained in greater detail elsewhere herein.

With reference now to FIG. 6, the knife 100 is shown in an intermediate pre-retraction configuration PR. The pre-retraction configuration shows the engagement member 107 near the back of the guide channel 108 as a user (not shown) pulls the engagement member 107 rearward as indicated by an arrow 114. In this configuration, the front detent mechanism 139 is nearly fully compressed by the front cam portion 128 of the slide plate 121 to nearly release the knife blade 117 in order to move back from the deployed position into the retracted or stowed position, as shown in FIG. 3. Once the engagement member 107 is moved back in the guide channel 108 a bit further, the front detent mechanism 139 will compress further and no longer obstruct the blade tang 130, and, as a result, the knife blade 117 will move back to the retracted or stowed position under a retraction force generated by the slider cartridge 119.

In particular, in the pre-retraction configuration, the front catch 123b near the front end 113 of the knife handle 101 is caught or hooked onto the blade pin 141 and pulled away from the slot 129 in the front end of the slider plate 121 to load the biasing or spring elements 125 to generate the aforementioned retraction force. Once the blade 100 is free to move rearward (i.e., by the compression of the front detent mechanism 139 described above), the built-up retraction force will pull the knife blade 117 back into the handle 101 to return the knife 100 to the stowed configuration S shown in FIG. 3.

FIGS. 7 and 8 show perspective views of the slider cartridge 119 apart from the remainder of the knife 100 from opposing sides 131, 133. As shown, the slider cartridge 119 includes the slider plate 121, the opposing catches 123a, 123b, and the biasing or spring elements 125 in a self-retained assembly. As previously described, the opposing catches 123a, 123b each include a catch structure 126 having opposing catch tabs 127 that protrude outwardly from a center or centerline of the catches 123a, 123b beyond a width of the respective engagement slot 129 of the slider plate 121. The opposing catch tabs 127 are configured to abut or hook behind the back side 133 of the slider plate 121, overlapping a portion of the back side 133 of the slider plate 121 adjacent to the engagement slots 129. With the opposing catch tabs 127 protruding beyond the slot width of the engagement slots 129, the blade pin 141 can be securely held in place by the slider cartridge 119 and will become readily available to safely deploy the knife blade 117. The catch engagement slots 129 may be provided in a form factor that is configured to nest with the opposing ends of the slider plate 121, such that the catch engagement slots 129 may assist in retaining the opposing pair of catches 123a, 123b on the slider plate 121 in the self-retained assembly. However, other forms of the engagement slots 129 and catch structures 126 may be used in varying configurations as needed. The catches 123a, 123b may remain at least slightly biased toward each other by the biasing or spring elements 125 to further assist in holding the slider cartridge 119 together in a self-retained assembly. In this configuration, the slider cartridge 119 may be manipulated in space apart from the remainder of the knife 100 during assembly with little risk of disassembly.

In view of the above, embodiments of the present disclosure may also include a method of assembling an out-the-knife 100 having a knife handle 101 and a knife blade 117 that is selectively deployable out of the front end 113 of the knife handle 117 to move from a stowed position within the knife handle 101 to a deployed position out the front end 113 of the knife handle 101. The method of assembly includes providing a slider plate 121, a pair of opposing catches 123a, 123b, and at least one biasing or spring element 125, and then configuring the pair of opposing catches 123a, 123b on opposing ends of the slider plate 121 under the bias of the at least one biasing or spring element 125 in order to form a self-retained slider cartridge 119. Thereafter, the slider cartridge 119 may be positioned between opposing portions 103, 105 of the knife handle 101 so that the slider cartridge 119 may be manipulable in space apart from the portions 103, 105 of the knife handle 101 and the knife blade 117.

Aspects of the various embodiments described above can be combined to provide further embodiments. In general, in the following claims, the terms used should not be construed to limit the claims to the specific embodiments disclosed in the specification and the claims but should be construed to include all possible embodiments along with the full scope of equivalents to which such claims are entitled.

1. A slider cartridge for an out-the-front knife having a knife handle and a knife blade that is selectively deployable out of a front of the knife handle to move from a stowed position within the handle to a deployed position out of the handle, the slider cartridge comprising:
a slider plate;
a pair of opposing catches; and
at least one biasing element,
wherein the pair of opposing catches are configured to be retained on opposing ends of the slider plate under a bias of the at least one biasing element in a self-retained assembly that is manipulable in space apart from the knife handle and the knife blade.

2. The slider cartridge of claim 1, wherein each of the pair of catches includes opposing tabs that are operable to assist in securing each respective catch on a respective one of the opposing ends of the slider plate, the opposing tabs protruding outwardly from a center of the catch to a side of the slider plate.

3. The slider cartridge of claim 2, wherein the slider plate includes a respective catch engaging slot on each of the opposing ends of the slider plate to insertably receive a respective one of the opposing catches.

4. The slider cartridge of claim 3, wherein the catch engaging slots are defined by a slot width, and wherein the opposing tabs of each of the opposing catches protrude outwardly beyond the slot width such that the opposing tabs overlap with portions of the slider plate adjacent to the catch engaging slots.

5. The slider cartridge of claim 4, wherein the opposing tabs of each of the opposing catches are configured to abut a backside of the slider plate to assist in retaining the opposing catches on the slider plate in the self-retained assembly.

6. The slider cartridge of claim 4, wherein a slider plate engaging end of each of the opposing catches, which includes the opposing tabs, is provided in a form factor that is configured to nest with the opposing ends of the slider plate to assist in retaining the opposing catches on the slider plate in the self-retained assembly.

7. The slider cartridge of claim 1 wherein each of the opposing catches includes at least one aperture configured to detachably receive a respective end of the at least one biasing element such that, in an assembled state of the slider cartridge, the at least one biasing element extends between the opposing catches.

8. The slider cartridge of claim 1 further comprising two biasing elements coupled between the opposing catches and extending along an outer face of the slider plate.

9. The slider cartridge of claim 1 wherein the pair of opposing catches are of identical form.

10. An out-the-front knife comprising the slider cartridge of claim 1.

11. The out-the-front knife of claim 10, further comprising:
a detent mechanism, the detent mechanism positioned at a rear end of the out-the-front knife within the knife handle to interact with a tang of the knife blade to secure the knife blade in the stowed position until a bias of the detent mechanism is overcome by movement of the slider plate.

12. The out-the-front knife of claim 10, further comprising:
a detent mechanism, the detent mechanism positioned at a front end of the out-the-front knife within the knife handle to interact with a tang of the knife blade to secure the knife blade in the deployed position until a bias of the detent mechanism is overcome by movement of the slider plate.

13. The out-the-front knife of claim 10, further comprising:
a moveable engagement member coupled to the knife handle to move in fore and aft directions and operable in conjunction with the slider plate to move the knife blade between the stowed position and the deployed position.

14. An out-the-front knife, comprising:
a knife handle;
a knife blade that is selectively deployable out of a front of the knife handle to move from a stowed position within the handle to a deployed position out of the handle; and
a slider cartridge having a slider plate, a pair of opposing catches, and at least one biasing element coupled to the opposing catches to bias the opposing catches toward each other, each of the catches including a pair of opposing tabs extending outwardly from a center of the catch beyond a respective catch engaging slot in each of a respective end of the slider plate to assist in securing the catches on the slider plate in a self-retained assembly.

15. The out-the-front knife of claim 14, wherein the catch engaging slots are defined by a slot width, and wherein the opposing tabs of each of the opposing catches protrude outwardly beyond the slot width such that the opposing tabs overlap with portions of the slider plate adjacent to the catch engaging slots.

16. The out-the-front knife of claim 15, wherein the opposing tabs of each of the opposing catches are configured to abut a backside of the slider plate to assist in retaining the opposing catches on the slider plate in the self-retained assembly.

17. The out-the-front knife of claim 15, wherein a slider plate engaging end of each of the opposing catches, which includes the opposing tabs, is provided in a form factor that is configured to nest with the opposing ends of the slider plate to assist in retaining the opposing catches on the slider plate in the self-retained assembly.

18. The out-the-front knife of claim 14 wherein the slider cartridge is configured to interact with a first detent mechanism at a rear end of the knife handle to assist in deploying the knife blade from the stowed configuration and to interact with a second detent mechanism at a front end of the knife handle to assist in returning the knife blade to the stowed configuration.

19. A method of assembling an out-the-front knife having a knife handle and a knife blade that is selectively deployable out of a front of the knife handle to move from a stowed position within the handle to a deployed position out of the handle, the method comprising:
providing a slider plate, a pair of opposing catches, and at least one biasing element; and
configuring the pair of opposing catches on opposing ends of the slider plate under a bias of the at least one biasing element to form a self-retained slider cartridge.

20. The method of claim 19, further comprising:
positioning the self-retained slider cartridge between opposing portions of the knife handle, the slider cartridge being manipulable in space apart from the portions of the knife handle and the knife blade.
